(19) United States
(12) Patent Application Publication
(10) Pub. No.: US 2016/0314611 A1
(43) Pub. Date: Oct. 27, 2016

(54) RAY TRACING APPARATUS AND METHOD

(71) Applicant: SAMSUNG ELECTRONICS CO., LTD., Suwon-si (KR)

(72) Inventors: Youngsam SHIN, Hwaseong-si (KR); Wonjong LEE, Seoul (KR); Seokjoong HWANG, Seoul (KR)

(73) Assignee: SAMSUNG ELECTRONICS CO., LTD., Suwon-si (KR)

(21) Appl. No.: 15/057,814

(22) Filed: Mar. 1, 2016

(30) Foreign Application Priority Data
Apr. 21, 2015 (KR) 10-2015-0056004

(51) Int. Cl. G06T 15/06; G06T 15/00; G06T 15/40; G06T 15/50; G06T 15/55

(52) U.S. Cl. CPC G06T 15/06; G06T 15/506; G06T 15/55; G06T 15/40; G06T 15/005

(57) ABSTRACT

A ray tracing apparatus includes a ray generator configured to generate a ray, and a traverser configured to perform a ray-node intersection test for the ray on a first node included in an acceleration structure, and perform the ray-node intersection test for the ray on a second node that is a child node of the first node using values obtained by calculation during the ray-node intersection test on the first node. A first minimum value representing the first node on a first coordinate axis is equal to a second minimum value representing the second node on the first coordinate axis, or a first maximum value representing the first node on the first coordinate axis is equal to a second maximum value representing the second node on the first coordinate axis.

### CROSS-REFERENCE TO RELATED APPLICATION(S)

This application claims the benefit under 35 USC 119(a) of Korean Patent Application No. 10-2015-0056004 filed on Apr. 21, 2015, in the Korean Intellectual Property Office, the entire disclosure of which is incorporated herein by reference for all purposes.

### BACKGROUND

1. Field

This application relates to a ray tracing apparatus and method capable of reducing an amount of required calculation during a ray-node intersection test.

2. Description of Related Art

In general, a 3-dimensional rendering is an image processing in which data of a 3-dimensional object is synthesized into images to be seen from a view point of a camera.

Rendering methods include a rasterization method of generating an image while projecting the 3-dimensional object onto a screen, and a ray tracing method of generating an image by tracing a path of an incident light along a ray toward each pixel of an image from the view point of the camera.

The ray tracing method has an advantage of generating a high quality image through reflecting physical properties of a light such as reflection, refraction, and penetration in rendering results; however, a high-speed rendering thereof is difficult due to a relatively enormous amount of calculation.

Factors requiring a large amount of calculation in ray tracing performance are generation and traversal (TRV) of an acceleration structure (AS) that spatially divides scene objects to be rendered, and an intersection test (IST) between a ray and a primitive.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a ray tracing apparatus includes a ray generator configured to generate a ray; and a traverser configured to perform a ray-node intersection test for the ray on a first node of an acceleration structure; and perform the ray-node intersection test for the ray on a second node that is a child node of the first node using values obtained by calculation during the ray-node intersection test on the first node; wherein a first minimum value representing the first node on a first coordinate axis is equal to a second minimum value representing the second node on the first coordinate axis, or a first maximum value representing the first node on the first coordinate axis is equal to a second maximum value representing the second node on the first coordinate axis.

A third minimum value representing the first node on a second coordinate axis may be equal to a fourth minimum value representing the second node on the second coordinate axis, and a third maximum value representing the first node on the second coordinate axis may be equal to a fourth maximum value representing the second node on the second coordinate axis.

A difference between the first minimum value and the first maximum value of the first node on the first coordinate axis may be larger than a difference between the third minimum value and the third maximum value of the first node on the second coordinate axis.

The traverser may be further configured to receive data of the acceleration structure from an external memory.

The traverser may be further configured to receive encoded data of the second node and a third node that is another child node of the first node; decode the received encoded data to obtain decoded data; and perform a ray-node intersection test for the ray on the second node and the third node using the decoded data and the values obtained by calculation during the ray-node intersection test on the first node; and the encoded data of the second node and the third node may include three values selected from the second minimum value and the second maximum value representing the second node on the first coordinate axis, and a third minimum value and a third maximum value representing the third node on the first coordinate axis, the three values being represented as relative values with respect to a remaining value as a reference value.

The reference value may be any one value of the second minimum value, the second maximum value, the third minimum value, and the third maximum value that is equal to either the first minimum value or the first maximum value of the first node.

The traverser may be further configured to determine a leaf node intersecting with the ray; and the ray tracing apparatus may further include an intersection tester configured to receive the leaf node from the traverser; and perform an intersection test between a primitive included in the leaf node and the ray.

The intersection tester may be further configured to determine a hit point of a primitive intersecting with the ray; and the ray tracing apparatus further may include a shader configured to receive the hit point of the primitive intersecting with the ray from the intersection tester; and determine a color value of a pixel at the hit point.

In another general aspect, a ray tracing method includes generating a ray; performing a ray-node intersection test for the ray on a first node included in an acceleration structure; and performing a ray-node intersection test for the ray on a second node that is a child node of the first node using values obtained by calculation during the ray-node intersection test on the first node; wherein a first minimum value representing the first node on a first coordinate axis is equal to a second minimum value representing the second node on the first coordinate axis, or a first maximum value representing the first node on the first coordinate axis is equal to a second maximum value representing the second node on the first coordinate axis.

A third minimum value representing the first node on a second coordinate axis may be equal to a fourth minimum value representing the second node on the second coordinate axis, and a third maximum value representing the first node on the second coordinate axis may be equal to a fourth maximum value representing the second node on the second coordinate axis.

A difference between the first minimum value and the first maximum value of the first node on the first coordinate axis may be larger than a difference between the third minimum value and the third maximum value of the first node on the second coordinate axis.

The ray tracing method may further include receiving data of the acceleration structure from an external memory.

The performing of the ray-node intersection test on the second node may include receiving encoded data of the second node and a third node that is another child node of the first node; decoding the received encoded data to obtain decoded data; and performing a ray-node intersection test for the ray on the second node and the third node using the decoded data and the values obtained by calculation during the ray-node intersection test on the first node; wherein the encoded data of the second node and the third node may include three values selected from the second minimum value and the second maximum value representing the second node on the first coordinate axis, and a third minimum value and a third maximum value representing the third node on the first coordinate axis, the three values being represented as relative values with respect to a remaining value as a reference value.

The reference value may be any one of the second minimum value, the second maximum value, the third minimum value, and the third maximum value that is equal to either the first minimum value or the first maximum value of the first node.

The ray tracing method may further include determining a leaf node intersecting with the ray; and performing an intersection test between a primitive included in the leaf node and the ray.

The ray tracing method may further include determining a hit point of a primitive intersecting with the ray; and determining a color value of a pixel at the hit point.

In another general aspect, a non-transitory computer-readable storage medium stores instructions to cause computing hardware to perform the method described above.

Other features and aspects will be apparent from the following detailed description, the drawings, and the claims.

### BRIEF DESCRIPTION OF THE DRAWINGS

FIG. 1 shows a diagram illustrating an example of a general ray tracing method;

FIG. 2 shows a diagram illustrating an example of a ray tracing method of this application.

FIG. 3 shows a diagram illustrating an example of an acceleration structure.

FIG. 4 shows a block diagram illustrating an example of a configuration of a ray tracing system.

FIG. 5 shows a reference diagram illustrating an example of an acceleration structure generating method.

FIG. 6 shows a reference diagram illustrating an example of a method of encoding acceleration structure data.

FIG. 7 shows a diagram illustrating numbers of calculations needed for a ray-node intersection test for a parent node and a child node.

FIG. 8 shows a flow chart illustrating an example of a ray tracing method.

FIG. 9 shows a flow chart illustrating another example of a ray tracing method.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

As used herein, the term “and/or” includes any and all combinations of one or more of the associated listed items. Expressions such as “at least one of,” when preceding a list of elements, modify the entire list of elements, and do not modify the individual elements of the list.

Throughout the specification, general terms that are widely used today are selected from a consideration of functions disclosed in this application, but they may vary depending on the intention of one of ordinary skill in the art, precedence, emergence of new technologies, and other factors. In addition, in special cases, arbitrarily selected terms may be used, where a detailed description of the meaning of such terms is provided at appropriate portions of the specification. Thus, terms in the specification are to be defined not by simple nomenclature of terms, but by meaning of terms and content throughout the specification.

Throughout the specification, when a portion “includes” an element, another element may be further included, rather than excluding the existence of the other element, unless otherwise described.

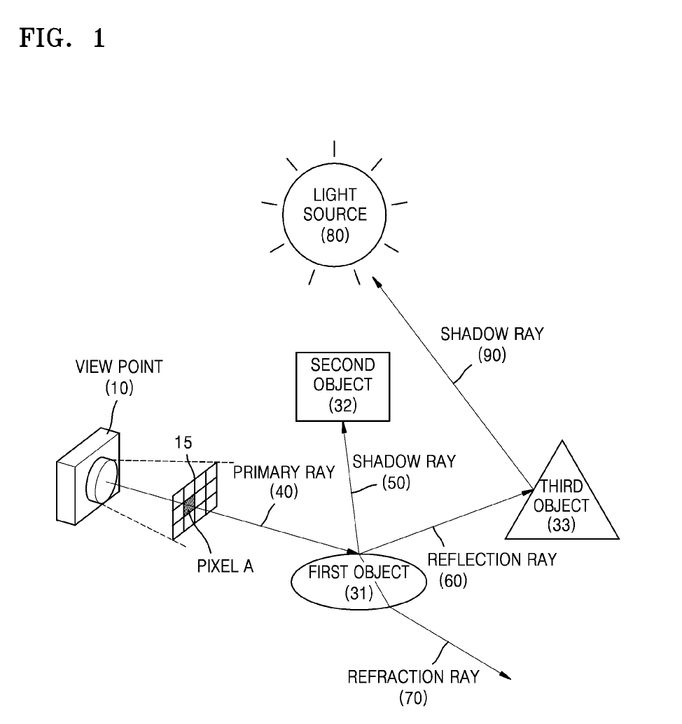

FIG. 1 shows a diagram illustrating an example of a general ray tracing method.

As illustrated in FIG. 1, a 3-dimensional modeling includes a light source 80, a first object 31, a second object 32, and a third object 33. In FIG. 1, the first object 31, the second object 32, and the third object 33 are presented as 2-dimensional objects; however, this is only for the convenience of description, and the first object 31, the second object 32, and the third object 33 are actually 3-dimensional objects.

It may be assumed that the first object 31 has both a reflectivity and a refractive index larger than zero, and the second object 32 and the third object 33 have both a reflectivity and a refractive index equal to zero. In other words, it may be assumed that the first object 31 reflects and refracts light and both the second object 32 and the third object 33 neither reflect nor refract light.

In the 3-dimensional modeling in FIG. 1, a rendering apparatus (such as a ray tracing apparatus) determines a view point 10 to generate a 3-dimensional image and determines an image screen 15 according to the determined view point 10. Once the view point 10 and the image screen 15 are determined, a ray tracing apparatus 100 generates a ray for every pixel on the image screen 15. For example, as illustrated in FIG. 1, when a resolution of the image screen 15 is 4 by 3, the ray tracing apparatus generates a ray corresponding to each of 12 pixels.

Hereinafter, a ray for one pixel (pixel A) will be described below.

Referring to FIG. 1, a primary ray 40 proceeds toward pixel A from the view point 10. The primary ray 40 passes through a 3-dimensional space and reaches the first object 31. The first object 31 includes a set of unit areas (hereinafter, referred to as primitives). For example, a primitive may be a polygon, such as a triangle or a quadrilateral. Below, a case in which the primitive is a triangle is described.

At a hit point of the primary ray 40 and the first object 31, a shadow ray 50, a reflection ray 60, and a refraction ray 70 are generated. The shadow ray 50, the reflection ray 60, and the refraction ray 70 are referred to as secondary rays.

The shadow ray 50 is generated toward the light source 80 from the hit point. The reflection ray 60 is generated in a direction corresponding to an incident angle of the primary ray 40, while a weighted value is applied thereto according to the reflectivity of the first object 31. The refraction ray 70 is generated in a direction corresponding to the incident angle of the primary ray 40 and a refractive index of the first object 31, and a weighted value is applied thereto according to the refractive index of the first object 31.

The ray tracing apparatus 100 determines whether the hit point is exposed to the light source 80 using the shadow ray 50. For example, as illustrated in FIG. 1, when the shadow ray 50 encounters the second object 32, a shadow is generated at the hit point where the shadow ray 50 has been generated. In addition, the ray tracing apparatus 100 determines whether the refraction ray 70 and the reflection ray 60 reach other objects. For example, as illustrated in FIG. 1, no object exists in a moving direction of the refraction ray 70, while the reflection ray 60 reaches the third object 33. Accordingly, the ray tracing apparatus 100 identifies coordinates and color information of the hit point on the third object 33, and generates a shadow ray 90 from the hit point of the third object 33 toward the light source 80. At this time, the ray tracing apparatus 100 determines whether the shadow ray 90 is exposed to the light source 80.

When both the reflectivity and the refraction index of the third object 33 are zero, neither a reflection ray nor a refraction ray with respect to the third object 33 is generated.

As described above, the ray tracing apparatus 100 analyzes the primary ray 40 for the pixel A and all rays derived from the primary ray 40, and determines a color value of the pixel A based on the obtained analysis results. The determining of the color value of the pixel A is influenced by the color of the primary ray 40 at the hit point, the color of the reflection ray 60 at the hit point, and whether the shadow ray 50 reaches the light source 80.

The ray tracing apparatus 100 performs the above-mentioned process for all pixels of the image screen 15, thereby configuring the image screen 15.

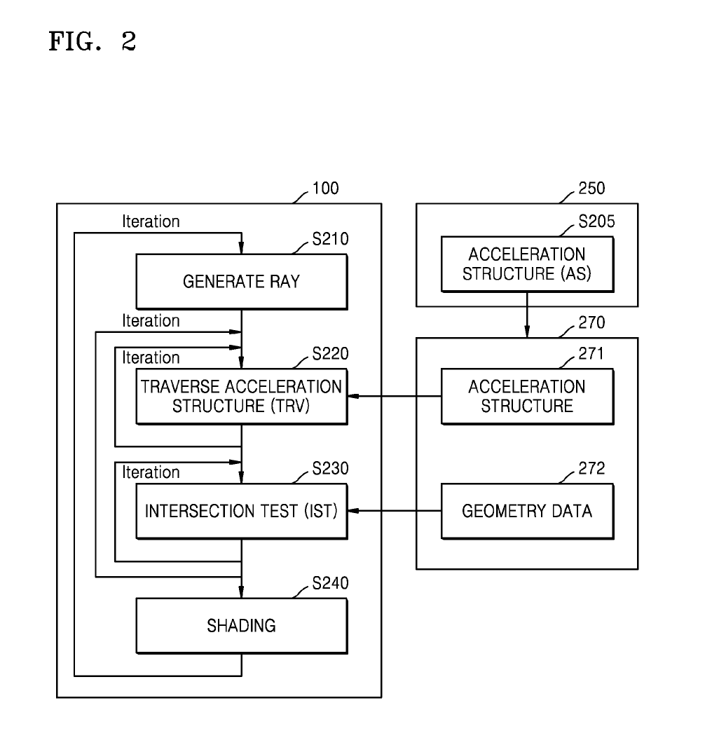

FIG. 2 shows a diagram illustrating an example of a ray tracing method of this application.

Referring to FIG. 2, a ray tracing processing system includes the ray tracing apparatus 100, an external memory 270, and an acceleration structure generator 250.

The ray tracing apparatus 100 generates rays (S210). Rays include a primary ray generated from the view point and rays derived from the primary ray. For example, as illustrated in FIG. 1, the ray tracing apparatus 100 generates the primary ray from the view point 10 and a secondary ray at a hit point of the primary ray and an object. The secondary ray may be a reflection ray, a refraction ray, or a shadow ray that is generated at the hit point where the primary ray and the object intersect.

In some examples, the ray tracing apparatus 100 generates a tertiary ray at the hit point of the secondary ray and an object. The ray tracing apparatus 100 may continuously generate rays until one ray does not intersect with the object, or until rays have been generated a predetermined number of times.

The ray tracing apparatus 100 reads an acceleration structure (AS) from the external memory 270 and traverses the acceleration structure based on the generated rays (S220).

An acceleration structure (AS) 271 is generated by the acceleration structure generator 250, and the acceleration structure 271 that is generated is stored in the external memory 270.

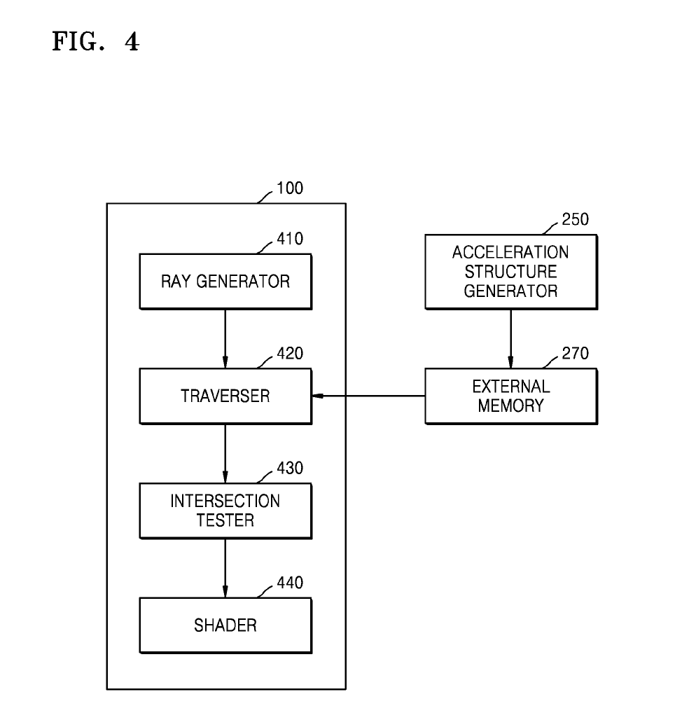

The acceleration structure generator 250 generates an acceleration structure including location information about objects in the 3-dimensional space (S205). The acceleration structure generator 250 divides the 3-dimensional space into a hierarchical tree-type structure. The acceleration structure generator 250 may generate various types of acceleration structures. For example, the acceleration structure generator 250 may generate an acceleration structure presenting relations among objects in the 3-dimensional space by applying a K-dimensional tree (KD-tree) or a bounding volume hierarchy (BVH). A method of generating the acceleration structure is described in detail with reference to FIG. 4.

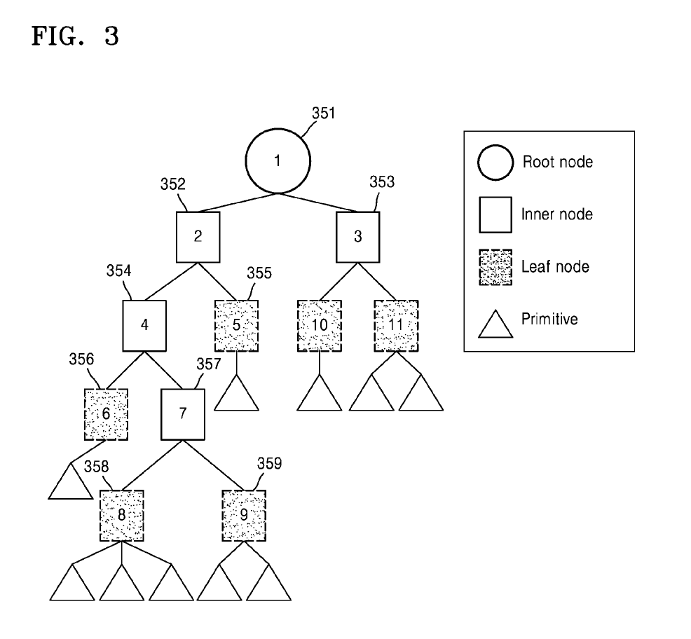

FIG. 3 shows a diagram illustrating an example of an acceleration structure.

Below, for the convenience of description, each node of the acceleration structure is referred to by a number written thereon. For example, a node 351 with a number 1 written thereon and presented as a circle referred to as a first node 351, a node 352 with a number 2 written thereon and presented as a square is referred to as a second node 352, and a node 355 with a number 5 written thereon and presented as a dashed square is referred to as a fifth node 355.

Referring to FIG. 3, the acceleration structure (AS) includes a top node, an inner node, a leaf node, and a primitive. In FIG. 3, the first node 351 indicates the top node. The top node is an uppermost node that does not have a parent node but has a child node only. For example, child nodes of the first node 351 are the second node 352 and the third node 353, and the parent node of the first node 351 does not exist. In addition, the second node 352 is the inner node. The inner node is a node that has both the parent node and the child node. For example, the parent node of the second node 352 is the first node 351, and child nodes of the second node 352 are a fourth node 354 and the fifth node 355. In addition, an eighth node 358 is the leaf node. The leaf node is a lowermost node that does not have a child node but has a parent node only. For example, the parent node of the eighth node 358 is a seventh node 357, and the child node of the eighth node 358 does not exist.

The leaf node includes one or more primitives that exist therein. For example, as illustrated in FIG. 3, a sixth node 356 being the leaf node includes one primitive, the eighth node 358 being the leaf node includes three primitives, and a ninth node 359 being the leaf node includes two primitives.

Referring to FIG. 2 again, the ray tracing apparatus 100 traverses information about the acceleration structure that has been read, and detects the leaf node with which the ray intersects. The ray tracing apparatus 100 repeats a traversal of the acceleration structure until the leaf node with which the ray intersects is detected.

The ray tracing apparatus 100 traverses the acceleration structure along any one path, and when the ray does not intersect with the leaf node on a traversed path, it traverses the acceleration structure along another path. For example, referring to FIG. 3, the ray tracing apparatus 100 may start the traversal from the second node 352 or the third node 353 that are lower nodes of the first node 351. When the traversal starts from the second node 352, the ray tracing apparatus 100 stores information about the third node 353 in a separate memory.

The ray tracing apparatus 100 determines whether the ray intersects with the second node 352, and when the ray intersects with the second node 352, the traversal is performed on at least one of the fourth node 354 and the fifth node 355 that are lower nodes of the second node 352.

When the traversal is performed to determine whether the fourth node 354 and the ray intersect each other, the ray tracing apparatus 100 stores information about the remaining node, that is, the fifth node 355, in the separate memory. When the fourth node 354 and the ray intersect each other, the ray tracing apparatus 100 performs the traversal on at least one of the sixth node 356 and the seventh node 357 that are lower nodes of the fourth node 354.

When the traversal is performed to determined whether the sixth node 356 and the ray intersect each other, the ray tracing apparatus 100 stores information about the remaining node, that is, the seventh node 357, in the separate memory. When the sixth node 356 and the ray intersect each other, the ray tracing apparatus 100 detects the sixth node 356 as the leaf node.

Accordingly, the ray tracing apparatus 100 performs the traversal along any one path and detects the leaf node, while storing information about the remaining node along another path in the separate memory. And after completion of the traversal along one path, the traversal is performed again on the remaining node about which information has been most recently stored. For example, after the sixth node 356 is detected as the leaf node, the traversal is performed again from the seventh node 357 about which information has been most recently stored.

Accordingly, the ray tracing apparatus 100 reduces an amount of calculation by performing the traversal along a path the most adjacent to the path along which the traversal has been completed, after one path is completely traversed, without performing the traversal along the path from the top node again.

When the leaf node is detected, the ray tracing apparatus 100 reads information about primitives included in the detected leaf node, that is, a geometry data 272, from the external memory 270.

Referring to FIG. 2 again, ray tracing apparatus 100 performs an intersection test between the ray and primitives using information about primitives that has been read from the external memory (S230). For example, when three primitives (a first primitive through a third primitive) are included in a detected leaf node, the ray tracing apparatus 100 detects a primitive with which the ray intersects by performing the intersection test between the first primitive and the ray, between the second primitive and the ray, and between the third primitive and the ray.

Accordingly, primitives with which the ray intersects are detected, and hit points where detected primitives and the ray intersect are calculated.

The ray tracing apparatus 100 performs shading on a pixel based on the results of the intersection test (S240). The ray tracing apparatus 100 determines the color value of the pixel based on information about the hit point and physical characteristics of the hit point. In addition, the ray tracing apparatus 100 determines the color value of a pixel in consideration of, for example, a basic color of a material at the hit point and an effect of the light source. For example, in the case of pixel A in FIG. 1, the ray tracing apparatus 100 determines the color value of the pixel A after considering all effects of the primary ray 40, and the refraction ray 70, the reflection ray 60, and the shadow ray 50 that are secondary rays.

When the ray tracing apparatus 100 completes the shading operation S240, the operation S210 is repeated. After the ray tracing apparatus 100 completes the shading for one pixel, shading is performed on another pixel by performing the operation S210 through the operation S240. The ray tracing apparatus 100 repeatedly performs the operation S210 through the operation S240 on all pixels constituting the image screen.

The ray tracing apparatus 100 receives data needed for a ray tracing from the external memory 270. The external memory 270 stores the acceleration structure 271 and the geometry data 272. The acceleration structure 271 is generated by the acceleration structure generator 250 and stored in the external memory 270. The geometry data 272 indicates information about primitives. A primitive may be a polygon, such as a triangle or a quadrilateral, and the geometry data 272 may indicate information about apices and location of a primitive included in the object. For example, when a primitive is a triangle, the geometry data 272 includes apex coordinates, normal vectors, and texture coordinates of three points of the triangle.

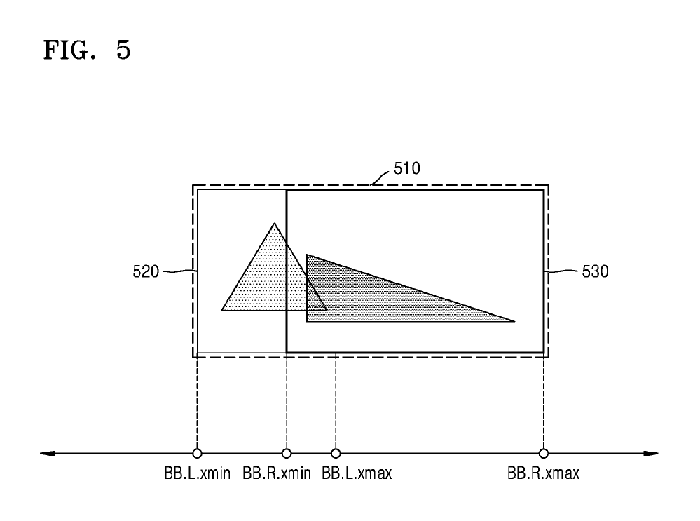

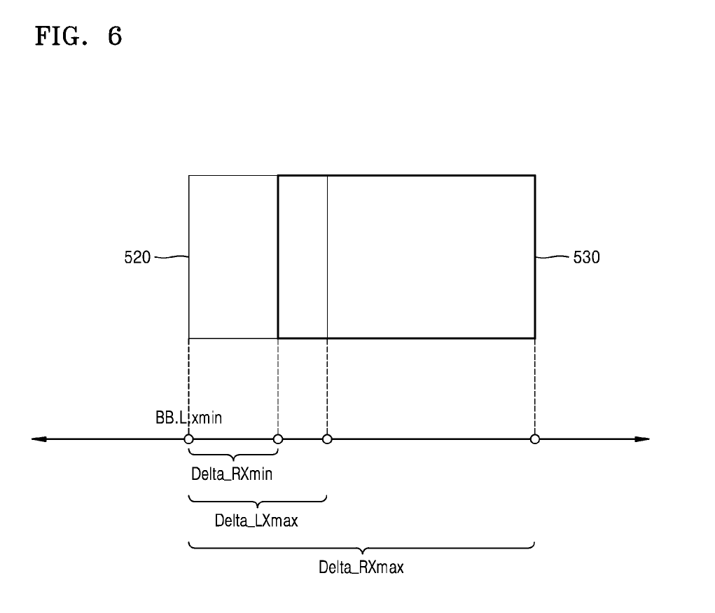

FIG. 4 shows a block diagram illustrating an example of a configuration of a ray tracing system. FIG. 5 shows a reference diagram illustrating an example of an acceleration structure generating method. FIG. 6 shows a reference diagram illustrating an example of a method of encoding acceleration structure data.

Referring to FIG. 4, the ray tracing system includes the ray tracing apparatus 100, the acceleration structure generator 250, and the external memory 270.

As described in FIG. 2, the acceleration structure generator 250 generates the acceleration structure including location information about objects in the 3-dimensional space by applying the K-dimensional tree (KD-tree) or the bounding volume hierarchy (BVH). Accordingly, as described in FIG. 3, the acceleration structure is a hierarchical tree structure including the parent node and child nodes of the parent node, which are a left child node and a right child node. An axis-aligned bounding box (AABB) aligns a space corresponding to each node of the acceleration structure on coordinate axes and presents them in a box shape, and the AABB is represented by a minimum value and a maximum value on each of an x-axis, an y-axis, and a z-axis. For example, the AABB corresponding to one node is represented by the minimum value on the x-axis or BB.xmin, the maximum value on the x-axis or BB.xmax, the minimum value on the y-axis or BB.ymin, the maximum value on the y-axis or BB.ymax, the minimum value on the z-axis or BB.zmin, and the maximum value on the z-axis or BB.zmax.

The acceleration structure generator 250 generates the AABB corresponding to the child node so that the AABB corresponding to the parent node and the AABB corresponding to the child node share either the minimum value or the maximum value on at least one of the x-axis, the y-axis, and the z-axis.

For example, referring to FIG. 5, a first AABB 510 is the AABB corresponding to the first node or the parent node, a second AABB 520 is the AABB corresponding to the second node or the left child node of the first node, and a third AABB 530 is the AABB corresponding to the third node or the right child node of the first node.

As illustrated in FIG. 5, the acceleration structure generator 250 generates the second AABB 520 corresponding to the second node or the left child node so that the minimum value on the x-axis, or BB.L.xmin, of the second AABB 520 that is the AABB corresponding to the left child node is equal to the minimum value on the x-axis, or BB.xmin, of the first AABB 510 that is the AABB corresponding to the parent node, and generates the third AABB 530 corresponding to the third node or the right child node so that the maximum value on the x-axis, or BB.R.xmax, of the third AABB 530 that is the AABB corresponding to the right child node is equal to the maximum value on the x-axis, or BB.xmax, of the first AABB 510 that is the AABB corresponding to the parent node,.

In FIG. 5, explanation is provided in connection with the x-axis, but the same explanation is also applicable to the y-axis and the z-axis.

In addition, the acceleration structure generator 250 generates the AABB corresponding to the child node by dividing the AABB corresponding to the parent node based on any one of the x-axis, the y-axis, and the z-axis. For example, the AABB corresponding to the child node may be generated by dividing the AABB corresponding to the parent node based on whichever one of the x-axis, the y-axis, and the z-axis has the largest difference among the difference between the minimum value and the maximum value representing the parent node on the x-axis, the difference between the minimum value and the maximum value representing the parent node on the y-axis, and the difference between the minimum value and the maximum value representing the parent node on the z-axis. In this case, only one of the minimum value and the maximum value on the x-axis, the minimum value and the maximum value on the y-axis, and the minimum value and the maximum value on the z-axis representing the child node will be different from values representing the parent node, and the five remaining values will be equal to values representing the parent node.

For example, when the first AABB corresponding to the parent node is divided based on the x-axis into only two AABBs (the second AABB and the third AABB), the second AABB and the first AABB will be different from each other in terms of a maximum value on the x-axis, while being the same in terms of their remaining values (the minimum value on the x-axis, the minimum value and the maximum value on the y-axis, and the minimum value and the maximum value on the z-axis). In addition, the third AABB and the first AABB will be different from each other in terms of a minimum value on the x-axis, while being the same in terms of their remaining values (the maximum value on the x-axis, the minimum value and the maximum value on the y-axis, and the minimum value and the maximum value on the z-axis).

In this case, when the intersection test is performed to determine whether the ray intersects with the second AABB, only the maximum value on the x-axis of the second AABB is calculated, and the remaining values (the minimum value on the x-axis, the minimum value and the maximum value on the y-axis, and the minimum value and the maximum value on the z-axis) are not calculated. Rather, the corresponding values calculated in the intersection test to determine whether the ray intersects with the first AABB are used as the remaining values for the second AABB.

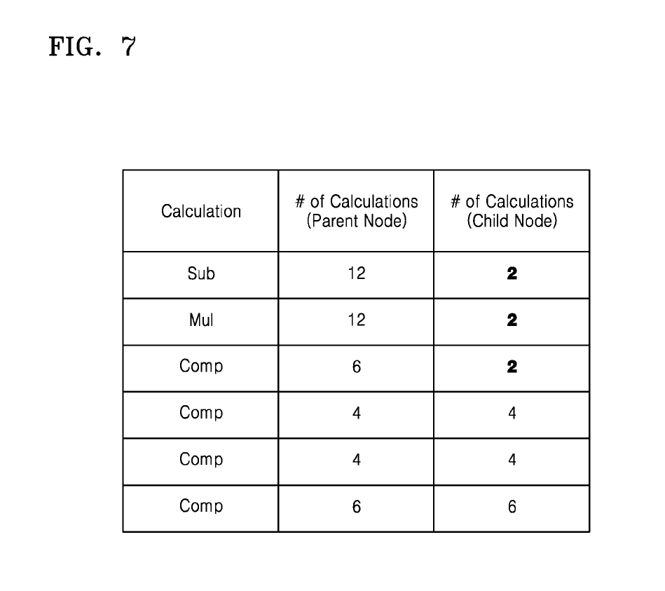

In addition, when the intersection test is performed to determine whether the ray intersects with the third AABB, only the minimum value on the x-axis of the third AABB is calculated, and the remaining values (the maximum value on the x-axis, the minimum value and the maximum value on the y-axis, and the minimum value and the maximum value on the z-axis) are not calculated. Rather the corresponding values calculated in the intersection test to determine whether the ray intersects with the first AABB are used as the remaining values for the third AABB. A detailed description of these cases is given below with reference to Table 1 and FIG. 7.

The acceleration structure generator 250 stores coordinate values (acceleration structure data) representing AABBs corresponding to each of nodes included in the acceleration structure in the external memory 270.

After determining any one of the minimum value on the x-axis (BB.L.xmin) and the maximum value on the x-axis (BB.L.xmax) of the second AABB 520 corresponding to the left child node, and the minimum value on the x-axis (BB.R.xmin) and the maximum value on the x-axis (BB.R.xmax) of the third AABB 530 corresponding to the right child node, as a reference value, the acceleration structure generator 250 encodes the remaining three values as relative values with respect to the reference value. For example, referring to FIG. 6, after determining the minimum value on the x-axis (BB.L.xmin) of the second AABB 520 corresponding to the left child node as the reference value, the maximum value on the x-axis (BB.L.xmax) of the second AABB 520 corresponding to the left child node is encoded as a relative value (Delta_LXmax) with respect to BB.L.xmin. In addition, the minimum value on the x-axis (BB.R.xmin) of the third AABB 530 corresponding to the right child node is encoded as a relative value (Delta_RXmin) with respect to BB.L.xmin, and the maximum value on the x-axis (BB.R.xmax) of the third AABB 530 corresponding to the right child node is encoded as a relative value (Delta_RXmax) with respect to BB.L.xmin.

The number of bits required to represent a relative value is smaller the number of bits that required to represent a coordinate value. Thus, as described in FIG. 6, a size of data of a reference value and relative values with respect to the reference values that are obtained by encoding coordinate values representing the AABB corresponding to the left child node and coordinate values representing the AABB corresponding to the right child node is smaller than a size of data of coordinate values representing AABBs corresponding to two child nodes. Accordingly, when coordinate values are encoded and stored, the capacity and bandwidth of a memory to store the acceleration structure data is reduced. In addition, an efficiency of a cache memory, for example, a traversal (TRV) cache memory, storing the acceleration structure data is enhanced.

Referring to FIG. 4 again, the ray tracing apparatus 100 includes a ray generator 410, a traverser 420, an intersection tester 430, and a shader 440.

The ray generator 410 generates the primary ray and rays derived from the primary ray as illustrated in the operation S210 of FIG. 2.

The traverser 420 performs a ray-node intersection test using the acceleration structure data. The traverser 420 includes the cache memory and stores a portion of the acceleration structure data in the external memory 270.

The traverser 420 performs the ray-node intersection test using an algorithm of Table 1 below. The algorithm of Table 1 to perform the ray-node intersection test is a slab method, which is an algorithm that is well known to one of ordinary skill in the art, so a detailed description thereof is omitted.

TABLE 1
Xmin = (BB.xmin − Ray.orgx)*Ray.dirx
Xmax = (BB.xmax − Ray.orgx)*Ray.dirx
Ymin = (BB.ymin − Ray.orgy)*Ray.diry
Ymax = (BB.ymax − Ray.orgy)*Ray.diry
Zmin = (BB.zmin − Ray.orgz)*Ray.dirz
Zmax = (BB.zmax − Ray.orgz)*Ray.dirz
Max of min (_min) = max (max(min(Xmin, Xmax), min(Ymin, Ymax)),
min(Zmin, Zmax))
Min of max (_max) = min (min(max(Xmin, Xmax), max(Ymin, Ymax)),
max(Zmin, Zmax))
Intersection ? (_min <= _max) && (_max >= Ray.tmin) && (_min <=
hitt)

Referring to Table 1, six subtraction calculations and six multiplication calculations are needed to calculate Xmin, Xmax, Ymin, Ymax, Zmin, and Zmax. In addition, referring to Table 1, three comparison calculations for max(min(Xmin, Xmax), min(Ymin, Ymax)) and two comparison calculations to compare a result value of max(min(Xmin, Xmax), min(Ymin, Ymax)) with min(Zmin, Zmax) to obtain a value of max are needed to obtain Max of min (min). In addition, referring to Table 1, min(Xmin, Xmax), min(Ymin, Ymax), and min(Zmin, Zmax) that were obtained during the calculation of Max of min (min) are used to obtain Min of max (max). That is, when min(Xmin, Xmax), min(Ymin, Ymax), and min(Zmin, Zmax) are calculated during the calculation of Max of min (min), one of Xmin and Xmax, one of Ymin and Ymax, and one of Zmin and Zmax are obtained as minimum values, and thus the remaining values that are not obtained as the minimum values are maximum values max(Xmin, Xmax), max(Ymin, Ymax), and max(Zmin, Zmax). For example, if Xmax is obtained as a minimum value when min(Xmin, Xmax) is calculated, this means that Xmin must necessarily be a maximum value that would be obtained if max(Xmin, Xmax) were to be calculated. Thus, the three comparison calculations max(Xmin, Xmax), max(Ymin, Ymax), and max(Zmin, Zmax) do not need to be performed, and only two comparison calculations are needed to compare a result value of min(max(Xmin, Xmax), max(Ymin, Ymax)) with max(Zmin, Zmax) to obtain a value of min to obtain Min of max (max). In addition, referring to Table 1, three comparison calculations are needed to determine the conditions of (_min←max), (_max→Ray.tmin), and (_min←hitt).

FIG. 7 shows a diagram illustrating numbers of calculations needed for a ray-node intersection test for a parent node and a child node.

When the traverser 420 performs the ray-node intersection test on the parent node, as illustrated in FIG. 7, the traverser 420 performs the ray-node intersection test according to the algorithm sequence of Table 1 by sequentially performing 12 subtractions (sub)→12 multiplications (mul)→comparisons (comp)→4 comparisons (comp)→4 comparisons (comp)→6 comparisons (comp).

However, when the traverser 420 performs the ray-node intersection test on the left child node and the right child node, as described in FIG. 5, when the minimum value on the x-axis of the first AABB 510 corresponding to the first node (the parent node) is equal to the minimum value on the x-axis of the second AABB 520 corresponding to the second node (the left child node), a value of Xmin (X.L.min) for the second node (the left child node) is equal to the value of Xmin for the first node (the parent node). Thus, the traverser 420 omits the calculation of Xmin (X.L.min) for the second node (the left child node).

In addition, when the maximum value on the x-axis of the first AABB 510 corresponding to the first node (the parent node) is equal to the maximum value on the x-axis of the third AABB 530 corresponding to the third node (the right child node), Xmax (X.R.max) for the third node (the right child node) is equal to Xmax for the first node (the parent node). Thus, the traverser 420 omits the calculation of Xmax (X.R.max) for the third node (the left child node).

In addition, when the first AABB 510 corresponding to the first node is divided only with respect to the x-axis to generate the second AABB 520 corresponding to the second node and the third AABB 530 corresponding to the third node, values of y-axis coordinates (the minimum value and the maximum value on the y-axis) of the second AABB 520 and values of y-axis coordinates (the minimum value and the maximum value on the y-axis) of the third AABB 530 are equal to values of y-axis coordinates (the minimum value and the maximum value on the y-axis) of the first AABB 510. In addition, values of z-axis coordinates (the minimum value and the maximum value on the z-axis) of the second AABB 520 and values of z-axis coordinates (the minimum value and the maximum value on the z-axis) of the third AABB 530 are equal to values of z-axis coordinates (the minimum value and the maximum value on the z-axis) of the first AABB 510.

Accordingly, the traverser 420 omits the calculation of Ymin, Ymax, Zmin, and Zmax for the second node (the left child node), and the calculation of Ymin, Ymax, Zmin, and Zmax for the third node (the right child node). For example, during the ray-node intersection test on the second node and the third node, the traverser 420 calculates X.L.max and X.R.min only, and omits the other corresponding calculations, since X.L.min, Y.L.min, Y.L.max, Z.L.min, Z.L.max, X.R.max, Y.R.min, Y.R.max, Z.R.min, and Z.R.max are equal to the calculated values for the first node (the parent node).

Thus, when the traverser 420 performs the ray-node intersection test on the second node and the third node, that is, on the left child node and the right child node, as illustrated in FIG. 7, the traverser 420 performs the ray-node intersection test according to the algorithm sequence of Table 1 by sequentially performing 2 subtractions (sub)→2 multiplications (mul)→2 comparisons (comp)→4 comparisons (comp)→4 comparisons (comp)→6 comparisons (comp).

During the ray-node intersection test, the number of calculations needed for the child nodes when the AABB corresponding to the parent node is divided with respect to only one axis to generate the AABBs corresponding to the child nodes is reduced compared to the number of calculations needed for the parent node and compared to the conventional art by using the calculation results obtained for the parent node in the ray-node intersection test for the child nodes.

The traverser 420 performs the ray-node intersection test for nodes included in the acceleration structure and detects the leaf node intersecting with the ray. The detected leaf node is transmitted to the intersection tester 430.

In addition, the intersection tester 430 receives the leaf node intersecting with the ray transmitted by the traverser 420. The intersection tester 430 reads information about the primitives included in the leaf node that has been received, that is, the geometry data 272, from the external memory 270. The intersection tester 430 performs the intersection test between the ray and primitives using the read information about the primitives. For example, the intersection tester 430 performs the intersection test to find which primitive the ray intersects with among a plurality of primitives included in the leaf node that has been received. Accordingly, the intersection tester 430 detects primitives with which the ray intersects and calculate the hit points where detected primitives and the ray intersect.

The shader 440 receives the hit point calculated by the intersection tester 430. The shader 440 determines the color value of the pixel based on information about the hit point and physical characteristics of the hit point. In addition, the shader 440 determines the color value of the pixel in consideration of the basic color of the material at the hit point and the effect of the light source. For example, in the case of pixel A in FIG. 1, the shader 440 determines the color value of the pixel A in consideration of all effects of the primary ray 40, and the refraction ray 70, the reflection ray 60, and the shadow ray 50 that are secondary rays.

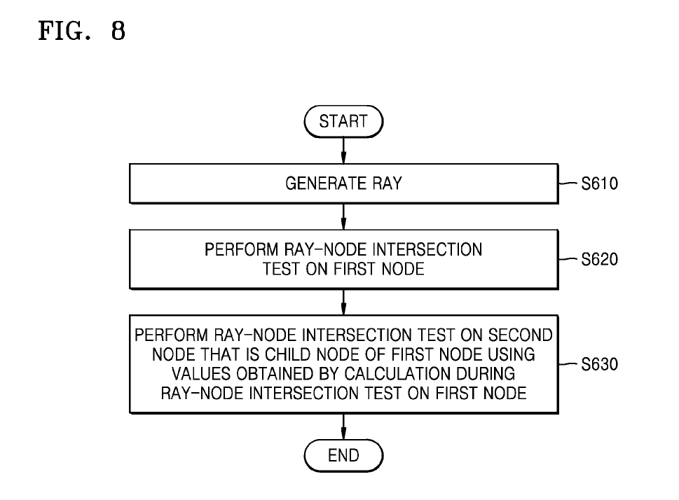

FIG. 8 shows a flow chart illustrating an example of a ray tracing method.

Referring to FIG. 8, the ray tracing apparatus 100 generates a ray (S610). Since the operation S610 corresponds to the operation S210 of FIG. 2, the detailed description thereof is omitted.

Referring to FIG. 8, the ray tracing apparatus 100 performs the ray-node intersection test on the first node (S620). For example, the ray tracing apparatus 100 performs the intersection test to determine whether the AABB corresponding to the first node and the ray intersect using the acceleration structure data and the algorithm described in Table 1.

The ray tracing apparatus 100 performs the ray-node intersection test on the second node that is the child node of the first node using values obtained by calculation in performing the ray-node intersection test on the first node (S630). For example, when the result of the ray-node intersection test on the first node shows that the ray intersects with the first node, the ray tracing apparatus 100 performs the ray-node intersection test on the second node that is the child node of the first node.

In addition, as described in FIG. 5, when a first minimum value on a first coordinate axis of the AABB corresponding to the first node is equal to a second minimum value on the first coordinate axis of the AABB corresponding to the second node, or a first maximum value on the first coordinate axis of the AABB corresponding to the first node is equal to a second maximum value on the first coordinate axis of the AABB corresponding to the second node, the ray tracing apparatus 100 uses values obtained by calculation during the ray-node intersection test performed on the first node when the ray-node intersection test is performed on the second node. For example, when the minimum value on the x-axis of the AABB corresponding to the first node is equal to the minimum value on the x-axis of the AABB corresponding to the second node, the value of Xmin (X.L.min) for the second node is equal to the value of Xmin for the first node. Thus, the ray tracing apparatus 100 omits the calculation of Xmin (X.L.min) for the second node and uses the value of Xmin for the first node.

The ray tracing apparatus 100 performs the ray-node intersection test on nodes included in the acceleration structure, and detects leaf nodes intersecting with the ray. The ray tracing apparatus 100 performs the intersection test between the ray and primitives, and calculates hit points of the ray and primitives using information about primitives included in the detected leaf nodes, that is, the geometry data. In addition, the ray tracing apparatus 100 determines the color value of the pixel based on information about the calculated hit point and physical characteristics of the hit point.

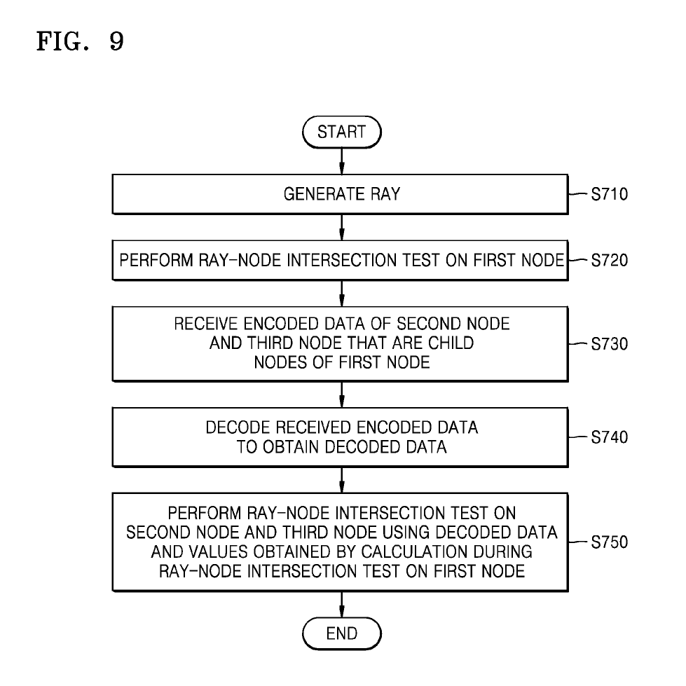

FIG. 9 shows a flow chart illustrating another example of a ray tracing method.

Referring to FIG. 9, the ray tracing apparatus 100 generates a ray (S710).

Since the operation S710 corresponds to the operation S210 of FIG. 2, the detailed description thereof is omitted.

Referring to FIG. 9, the ray tracing apparatus 100 performs the ray-node intersection test on the first node (S720). Since the operation S720 corresponds to the operation S620 of FIG. 8, the detailed description thereof is omitted.

The ray tracing apparatus 100 receives encoded data of the second node and the third node that are child nodes of the first node. After determining, as a reference value, any one of a minimum value on the x-axis (BB.L.xmin) and a maximum value on the x-axis (BB.L.xmax) of AABB corresponding to the second node (the left child node), and a minimum value on the x-axis (BB.R.xmin) and a maximum value on the x-axis (BB.R.xmax) of AABB corresponding to the third node (the right child node), the remaining three values are represented as relative values with respect to the reference value.

The ray tracing apparatus 100 decodes the received encoded data (S740). For example, encoded data including relative values with respect to the reference value are reconstructed to the original coordinate values.

The ray tracing apparatus 100 performs the ray-node intersection test on the second node and the third node using the decoded data and values obtained by calculation during the ray-node intersection test on the first node (S750).

Since the operation S750 corresponds to the operation S630 of FIG. 8 except for the use of the decoded data, the detailed description thereof is omitted.

The ray tracing apparatus 100, the acceleration structure generator 250, the ray generator 410, the traverser 420, the intersection tester 430, and the shader 440 in FIGS. 2 and 4 that perform the operations described herein with respect to FIGS. 1-9 are implemented by hardware components. Examples of hardware components include controllers, generators, drivers, memories, comparators, arithmetic logic units, adders, subtractors, multipliers, dividers, integrators, and any other electronic components known to one of ordinary skill in the art. In one example, the hardware components are implemented by computing hardware, for example, by one or more processors or computers. A processor or computer is implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices known to one of ordinary skill in the art that is capable of responding to and executing instructions in a defined manner to achieve a desired result. In one example, a processor or computer includes, or is connected to, one or more memories storing instructions or software that are executed by the processor or computer. Hardware components implemented by a processor or computer execute instructions or software, such as an operating system (OS) and one or more software applications that run on the OS, to perform the operations described herein with respect to FIGS. 1-9. The hardware components also access, manipulate, process, create, and store data in response to execution of the instructions or software. For simplicity, the singular term “processor” or “computer” may be used in the description of the examples described herein, but in other examples multiple processors or computers are used, or a processor or computer includes multiple processing elements, or multiple types of processing elements, or both. In one example, a hardware component includes multiple processors, and in another example, a hardware component includes a processor and a controller. A hardware component has any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 2, 8, and 9 that perform the operations described herein with respect to FIGS. 1-9 are performed by a processor or a computer as described above executing instructions or software to perform the operations described herein.

Instructions or software to control a processor or computer to implement the hardware components and perform the methods as described above are written as computer programs, code segments, instructions or any combination thereof, for individually or collectively instructing or configuring the processor or computer to operate as a machine or special-purpose computer to perform the operations performed by the hardware components and the methods as described above. In one example, the instructions or software include machine code that is directly executed by the processor or computer, such as machine code produced by a compiler. In another example, the instructions or software include higher-level code that is executed by the processor or computer using an interpreter. Programmers of ordinary skill in the art can readily write the instructions or software based on the block diagrams and the flow charts illustrated in the drawings and the corresponding descriptions in the specification, which disclose algorithms for performing the operations performed by the hardware components and the methods as described above.

The instructions or software to control a processor or computer to implement the hardware components and perform the methods as described above, and any associated data, data files, and data structures, are recorded, stored, or fixed in or on one or more non-transitory computer-readable storage media. Examples of a non-transitory computer-readable storage medium include read-only memory (ROM), random-access memory (RAM), flash memory, CD-ROMs, CD-Rs, CD+Rs, CD−RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks, and any device known to one of ordinary skill in the art that is capable of storing the instructions or software and any associated data, data files, and data structures in a non-transitory manner and providing the instructions or software and any associated data, data files, and data structures to a processor or computer so that the processor or computer can execute the instructions. In one example, the instructions or software and any associated data, data files, and data structures are distributed over network-coupled computer systems so that the instructions and software and any associated data, data files, and data structures are stored, accessed, and executed in a distributed fashion by the processor or computer.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A ray tracing apparatus comprising:
a ray generator configured to generate a ray; and
a traverser configured to:
perform a ray-node intersection test for the ray on a first node of an acceleration structure; and
perform the ray-node intersection test for the ray on a second node that is a child node of the first node using values obtained by calculation during the ray-node intersection test on the first node;
wherein a first minimum value representing the first node on a first coordinate axis is equal to a second minimum value representing the second node on the first coordinate axis, or a first maximum value representing the first node on the first coordinate axis is equal to a second maximum value representing the second node on the first coordinate axis.

2. The ray tracing apparatus of claim 1, wherein a third minimum value representing the first node on a second coordinate axis is equal to a fourth minimum value representing the second node on the second coordinate axis, and a third maximum value representing the first node on the second coordinate axis is equal to a fourth maximum value representing the second node on the second coordinate axis.

3. The ray tracing apparatus of claim 2, wherein a difference between the first minimum value and the first maximum value of the first node on the first coordinate axis is larger than a difference between the third minimum value and the third maximum value of the first node on the second coordinate axis.

4. The ray tracing apparatus of claim 1, wherein the traverser is further configured to receive data of the acceleration structure from an external memory.

5. The ray tracing apparatus of claim 1, wherein the traverser is further configured to:
receive encoded data of the second node and a third node that is another child node of the first node;
decode the received encoded data to obtain decoded data; and
perform a ray-node intersection test for the ray on the second node and the third node using the decoded data and the values obtained by calculation during the ray-node intersection test on the first node; and
the encoded data of the second node and the third node comprises three values selected from the second minimum value and the second maximum value representing the second node on the first coordinate axis, and a third minimum value and a third maximum value representing the third node on the first coordinate axis, the three values being represented as relative values with respect to a remaining value as a reference value.

6. The ray tracing apparatus of claim 5, wherein the reference value is any one value of the second minimum value, the second maximum value, the third minimum value, and the third maximum value that is equal to either the first minimum value or the first maximum value of the first node.

7. The ray tracing apparatus of claim 1, wherein the traverser is further configured to determine a leaf node intersecting with the ray; and
the ray tracing apparatus further includes an intersection tester configured to:
receive the leaf node from the traverser; and
perform an intersection test between a primitive included in the leaf node and the ray.

8. The ray tracing apparatus of claim 7, wherein the intersection tester is further configured to determine a hit point of a primitive intersecting with the ray; and
the ray tracing apparatus further comprises a shader configured to:
receive the hit point of the primitive intersecting with the ray from the intersection tester; and
determine a color value of a pixel at the hit point.

9. A ray tracing method comprising:
generating a ray;
performing a ray-node intersection test for the ray on a first node included in an acceleration structure; and
performing a ray-node intersection test for the ray on a second node that is a child node of the first node using values obtained by calculation during the ray-node intersection test on the first node;
wherein a first minimum value representing the first node on a first coordinate axis is equal to a second minimum value representing the second node on the first coordinate axis, or a first maximum value representing the first node on the first coordinate axis is equal to a second maximum value representing the second node on the first coordinate axis.

10. The ray tracing method of claim 9, wherein a third minimum value representing the first node on a second coordinate axis is equal to a fourth minimum value representing the second node on the second coordinate axis, and a third maximum value representing the first node on the second coordinate axis is equal to a fourth maximum value representing the second node on the second coordinate axis.

11. The ray tracing method of claim 10, wherein a difference between the first minimum value and the first maximum value of the first node on the first coordinate axis is larger than a difference between the third minimum value and the third maximum value of the first node on the second coordinate axis.

12. The ray tracing method of claim 9, further comprising receiving data of the acceleration structure from an external memory.

13. The ray tracing method of claim 9, wherein the performing of the ray-node intersection test on the second node comprises:
receiving encoded data of the second node and a third node that is another child node of the first node;
decoding the received encoded data to obtain decoded data; and
performing a ray-node intersection test for the ray on the second node and the third node using the decoded data and the values obtained by calculation during the ray-node intersection test on the first node;
wherein the encoded data of the second node and the third node comprises three values selected from the second minimum value and the second maximum value representing the second node on the first coordinate axis, and a third minimum value and a third maximum value representing the third node on the first coordinate axis, the three values being represented as relative values with respect to a remaining value as a reference value.

14. The ray tracing method of claim 13, wherein the reference value is any one of the second minimum value, the second maximum value, the third minimum value, and the third maximum value that is equal to either the first minimum value or the first maximum value of the first node.

15. The ray tracing method of claim 9, further comprising:
determining a leaf node intersecting with the ray; and
performing an intersection test between a primitive included in the leaf node and the ray.

16. The ray tracing method of claim 15, further comprising:
determining a hit point of a primitive intersecting with the ray; and
determining a color value of a pixel at the hit point.

17. A non-transitory computer-readable storage medium storing instructions to cause computing hardware to perform the method of claim 9.
